(19) United States
(12) Patent Application Publication
(10) Pub. No.: US 2024/0404496 A1
(43) Pub. Date: Dec. 5, 2024

(54) TECHNIQUES FOR GENERATING VIDEO EFFECTS FOR SING-ALONG SESSIONS

(71) Applicant: Apple Inc., Cupertino, CA (US)

(72) Inventors: Kevin M. O'NEIL, San Francisco, CA (US); Hans H. KIM, Santa Monica, CA (US); Scott W. WILSON, San Jose, CA (US)

(21) Appl. No.: 18/468,658

(22) Filed: Sep. 15, 2023

Related U.S. Application Data
(60) Provisional application No. 63/506,105, filed on Jun. 4, 2023.

(51) Int. Cl. G10H 1/36; H04N 21/4223; H04N 21/43; H04N 21/439

(52) U.S. Cl. CPC G10H 1/368; H04N 21/4223; H04N 21/43072; H04N 21/4394

(57) ABSTRACT

The embodiments set forth techniques for implementing a sing-along session. According to some embodiments, the techniques can be implemented by a computing device, and include the steps of (1) receiving audio feed content from at least one microphone, (2) receiving audio content that includes metadata that describes a plurality of characteristics of the audio content, (3) generating audio output content that is based on the audio feed content and the audio content, (4) receiving video feed content from at least one camera, (5) generating video output content that is based on: the video feed content, and the audio content and/or at least one characteristic of the plurality of characteristics of the audio content, and (6) outputting, to a media playback system: the audio output content, and the video output content.

### CROSS-REFERENCE TO RELATED APPLICATIONS

The present application claims the benefit of U.S. Provisional Application No. 63/506,105, entitled “TECHNIQUES FOR GENERATING VIDEO EFFECTS FOR SING-ALONG SESSIONS,” filed Jun. 4, 2023, the content of which is incorporated by reference herein in its entirety for all purposes.

### FIELD

The described embodiments relate generally to generating video effects for sing-along sessions. In particular, the described embodiments provide techniques for generating the video effects based on metadata and/or audio data of audio content. The described embodiments also provide techniques for generating the video effects based on audio and/or video feed content.

### BACKGROUND

It is well-known that humans are inherently inclined to sing along to songs. In particular, singing is a deeply ingrained and universal form of human expression that has been practiced across cultures and time periods. It taps into our natural instincts to communicate and connect with others. When we hear music, it has the power to evoke emotions, trigger memories, and create a sense of shared experience. Singing along allows us to actively participate in this musical journey, deepening our engagement and amplifying the impact of the music on our psyche.

One reason humans are inclined to sing along is the therapeutic and emotional release it provides. Singing has been shown to have numerous psychological benefits, including stress reduction, mood enhancement, and increased feelings of well-being. When we sing, our brains release endorphins, which are neurotransmitters that promote feelings of pleasure and happiness. In this regard, singing along to our favorite songs can be a cathartic experience that allows us to express and process our emotions in a safe and enjoyable manner.

Additionally, singing along to songs taps into our innate desire for social connection. It is well-known that music has the remarkable ability to bring people together and to foster a sense of unity and belonging. When we sing along, we join a collective experience, whether it's at a concert, a karaoke night, or simply singing along with friends and family at a gathering. This shared activity creates a sense of camaraderie and community, transcending barriers of age, culture, and background. In this regard, singing along allows us to connect with others on a deeper level and facilitates the forging of bonds and the building of relationships.

In addition, singing along to songs allows us to express our creativity and individuality. It gives us the freedom to interpret and personalize the music through our own voices and styles. Whether we have a melodic voice or not, singing along allows us to display our uniqueness and adds a personal touch to the songs we love. It becomes a form of self-expression and a way to connect with our inner selves.

Accordingly, it is desirable to provide implementations that enable individuals to sing along with music in fun and meaningful ways.

### SUMMARY

The described embodiments relate generally to generating video effects for sing-along sessions. In particular, the described embodiments provide techniques for generating the video effects based on metadata and/or audio data of audio content. The described embodiments also provide techniques for generating the video effects based on audio and/or video feed content.

One embodiment sets forth a method for implementing a sing-along session. According to some embodiments, the method can be implemented by a computing device, and includes the steps of (1) receiving audio feed content from at least one microphone, (2) receiving audio content that includes metadata that describes a plurality of characteristics of the audio content, (3) generating audio output content that is based on the audio feed content and the audio content, (4) receiving video feed content from at least one camera, (5) generating video output content that is based on: the video feed content, and the audio content and/or at least one characteristic of the plurality of characteristics of the audio content, and (6) outputting, to a media playback system: the audio output content, and the video output content.

Another embodiment sets forth a method for generating video effects for sing-along sessions. According to some embodiments, the method can be implemented by a computing device, and includes the steps of (1) receiving metadata that describes a plurality of characteristics of audio content, (2) generating, based on at least one characteristic of the plurality of characteristics, at least one video effect transition to take place within video output content to be paired with the audio content, (3) dynamically generating the video output content, where the video output content includes the at least one video effect transition, and (4) outputting the video output content to at least one display device, where playback of the video output content is synchronized with playback of the audio content such that the at least one video effect transition coincides with the at least one characteristic.

Other embodiments include at least one non-transitory computer readable storage medium configured to store instructions that, when executed by at least one processor included in a computing device, cause the computing device to carry out the various steps of any of the foregoing methods. Further embodiments include a computing device that includes at least one processor, and at least one memory storing instructions that, when executed by the at least one processor, cause the computing device to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a system diagram of a computing device that can be configured to perform the various techniques described herein, according to some embodiments.

FIG. 2 illustrates a conceptual diagram of a technique for generating video effects based on lyric information included in the metadata of audio content, according to some embodiments.

FIG. 3 illustrates a conceptual diagram of a technique for generating video effects based on valence information included in the metadata of audio content, according to some embodiments.

FIG. 4 illustrates a conceptual diagram of example video effects, as well as video effect transitions, according to some embodiments.

FIG. 5 illustrates a method for implementing a sing-along session, according to some embodiments.

FIG. 6 illustrates a method for generating video effects for sing-along sessions, according to some embodiments.

FIG. 7 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments relate generally to generating video effects for sing-along sessions. In particular, the described embodiments provide techniques for generating the video effects based on metadata and/or audio data of audio content. The described embodiments also provide techniques for generating the video effects based on audio and/or video feed content.

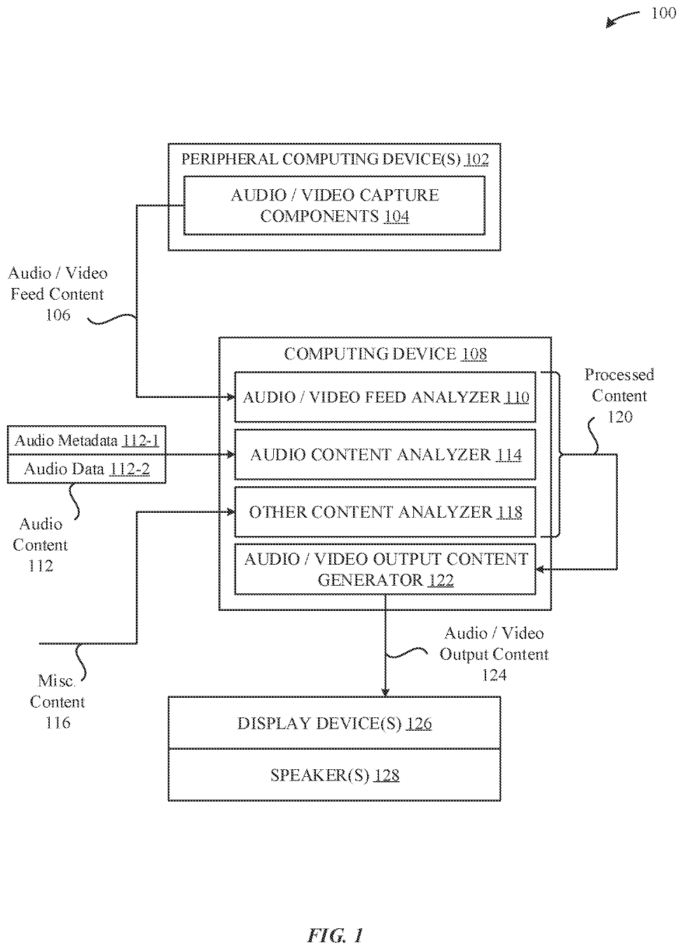

A more detailed discussion of these techniques is set forth below and described in conjunction with FIGS. 1-7, which illustrate detailed diagrams of systems and methods that can be used to implement these techniques.

FIG. 1 illustrates a block diagram of different components of a system 100 that can be configured to implement the various techniques described herein, according to some embodiments. As shown in FIG. 1, the system 100 can include peripheral computing devices 102, computing devices 108, display devices 126, and speakers 128. According to some embodiments, a given peripheral computing device 102/computing device 108 can represent any type, form, etc., of a computing device, such as a wearable computing device, a smartphone computing device, a tablet computing device, a laptop computing device, a desktop computing device, a set-top box computing device, a video game console, and so on. Although not illustrated in FIG. 1, those having skill in the art will understand that the peripheral computing device 102/computing device 108 can execute an operating system through which any number of software applications (e.g., native, third-party, etc.) can be implemented.

According to some embodiments, the computing device 108 can implement a variety of entities that carry out different functions. In particular, and as shown in FIG. 1, the entities can include an audio/video feed analyzer 110, an audio content analyzer 114, other content analyzer 118, and an audio/video output content generator 122. According to some embodiments, the audio/video feed analyzer 110 can be configured to receive audio/video feed content 106. A variety of approaches can be implemented that enable the computing device 108 to obtain audio/video feed content 106. For example, when the computing device 108 is implemented as a set-top box that does not possess cameras/microphones capable of capturing audio/video feed content 106, then the computing device 108 can interface with the one or more peripheral computing devices 102 to obtain the audio/video feed content 106. In particular, under one example approach, a single peripheral computing device 102 can represent a computing device—such as a smartphone, tablet, laptop, etc.—that includes audio/video capture components 104 (e.g., at least one camera/microphone) capable of (1) capturing audio/video feed content 106, and (2) transmitting the audio/video feed content 106 to the computing device 108. This approach can be beneficial in that it can reduce the number of devices needed to implement the system 100; however, if the peripheral computing device 102 is set at a distance from the individuals utilizing the system 100 (e.g., in order to obtain video feed content 106 that includes all of the individuals in the frame), then there may be deficiencies in gathering high-quality audio feed content 106 from the microphone of the peripheral computing device 102 (i.e., due to the distance, interfering audio, etc.).

Under another example approach, the aforementioned peripheral computing device 102 (e.g., a smartphone) can be utilized to capture video feed content 106, whereas an additional peripheral computing device 102—e.g., a smart remote of the computing device 108 (e.g., a set-top box) that includes at least one microphone-can be used to capture complementary audio feed content 106 to the video feed content 106. This approach can be beneficial in that it can cure the aforementioned deficiencies of the smartphone-only based approach given the smart remote can be held near to individuals' mouths to obtain high-quality audio feed content 106. It is noted that the foregoing examples are not meant to be limiting, and that any approach can be utilized to gather and provide audio/video feed content 106 to the computing device 108. It is further noted that the computing device 108 can include audio/video capture components 104 (e.g., at least one camera/microphone) to capture audio/video feed content 106, in which case the peripheral computing devices 102 would be supplemental or superfluous.

According to some embodiments, the audio/video feed analyzer 110 can be configured to receive/process the audio/video feed content 106. For example, with regard to the audio feed content 106, the audio/video feed analyzer 110 can be configured to isolate voice audio included in the audio feed content 106 from any background noise that is captured with the voice audio. The audio/video feed analyzer 110 can also be configured to filter, compress, etc., the aforementioned voice audio. It is noted that the foregoing examples are not meant to be limiting, and that the audio/video feed analyzer 110 can be configured to perform any type, form, etc., of processing on the audio feed content 106, at any level of granularity, without departing from the scope of this disclosure.

Additionally, with regard to the video feed content 106, the audio/video feed analyzer 110 can be configured to isolate objects detected within the video feed content 106, such as humans, pets, plants, etc. (depending on configurations, goals, etc.). The audio/video feed analyzer 110 can also be configured to scale, resize, compress, etc., the aforementioned isolated objects, the video feed content 106, and so on. It is noted that the foregoing examples are not meant to be limiting, and that the audio/video feed analyzer 110 can be configured to perform any type, form, of processing on the video feed content 106, at any level of granularity, without departing from the scope of this disclosure. As indicated in FIG. 1—and, as described below in greater detail—the audio/video feed content 106 that is received/processed by the audio/video feed analyzer 110 can be provided (along with other content produced by other entities executing on the computing device 108) as processed content 120 to the audio/video output content generator 122.

According to some embodiments, the audio content analyzer 114 can be configured to receive/process audio content 112 that can be received, for example, as a complete file, a stream of data, and so on. As shown in FIG. 1, the audio content 112 can include audio metadata 112-1 and audio data 112-2. According to some embodiments, the audio metadata 112-1 can include any type, form, etc., of data that is associated with and describes the audio content 112/audio data 112-2. For example, the audio metadata 112-1 can include characteristics that are specific to the audio content 112, such as description information, origin information, and so on. Moreover, the audio metadata 112-1 can include characteristics that are specific to the audio data 112-2, such as title, artist, album, album artist, track number, disc number, genre, year, duration, composer, lyricist, conductor, band, comment, beats per minute (BPM), key, rating, language, publisher, international standard recording code (ISRC), universal product code (UPC), copyright, original artist, compilation, mood, podcast, and artwork information.

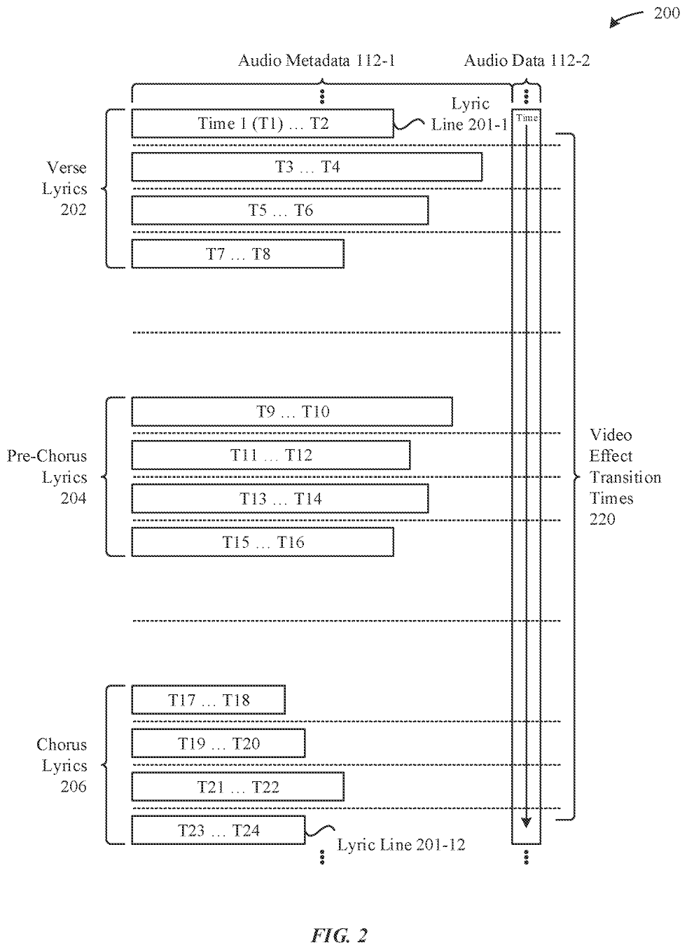

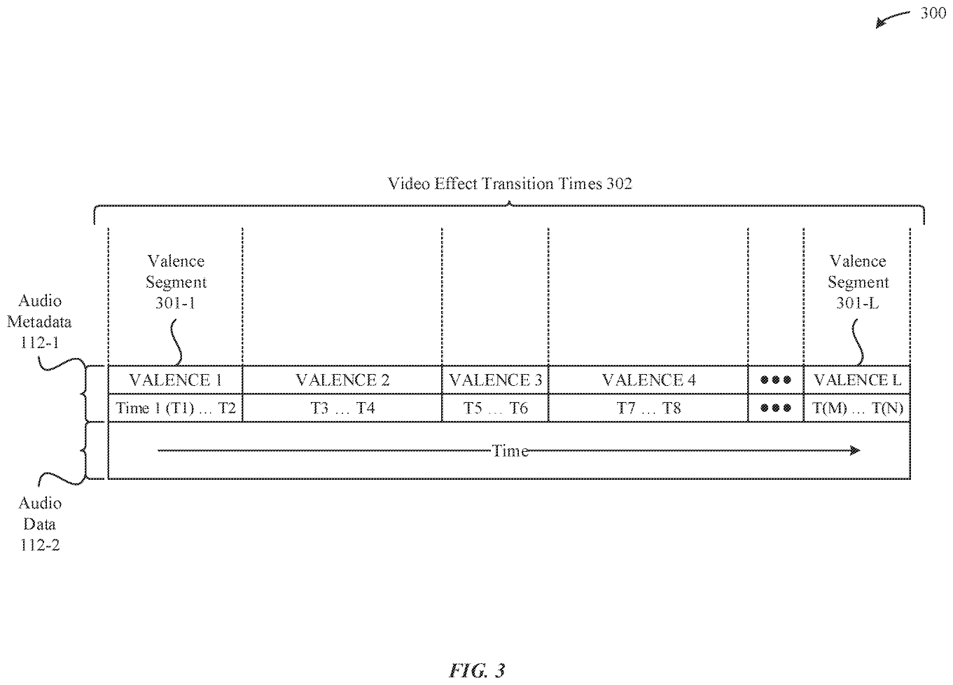

As described in greater detail herein, the audio metadata 112-1 can include additional characteristics that are specific to the audio data 112-2, such as lyric information, valence information, tempo information, and so on. According to some embodiments, and as described below in greater detail in conjunction with FIG. 2, the lyric information can represent lyrics included in the audio data 112-2 in any form and at any level of granularity. According to some embodiments, and as described below in greater detail in conjunction with FIG. 3, the valence information can represent different emotional qualities of different portions of the audio data 112-2 in any form and at any level of granularity. For example, a valence segment for a given portion of audio data 112-2 can be based on at least one underlying meaning of at least a portion of lyrics included in the given portion of the audio content, a tempo of the given portion of the audio content, a frequency band of the given portion of the audio content, and so on. Examples of categorizations for the valence segments can include, for example, a euphoric valence, an excited valence, a positive valence, a serene valence, a reflective valence, a neutral valence, a melancholic valence, a negative valence, an aggressive valence, and so on. It is noted that the foregoing examples are not meant to be limiting, and that any number of valence segments can be based on any aspect of the audio metadata 112-1/audio data 112-2, at any level of granularity, without departing from the scope of this disclosure.

According to some embodiments, the tempo information can represent the perceived (i.e., subjective) rate of the underlying BPM (i.e., objective) rate of the audio data 112-2 in any form and at any level of granularity. It is noted that some or all of the audio metadata 112-1 characteristics described herein can be pre-populated within the audio content 112, and that the audio content analyzer 114 can be configured to process the audio content 112 to derive other characteristics, if any, that are not pre-populated within the audio content 112. It is additionally that the foregoing examples are not meant to be limiting, and that the audio metadata 112-1 can include any number, type, etc., of characteristics, at any level of granularity, without departing from the scope of this disclosure. In any case, the audio content 112 that is received/processed by the audio content analyzer 114 can be provided (along with other content produced by other entities executing on the computing device 108) as processed content 120 to the audio/video output content generator 122.

According to some embodiments, the other content analyzer 118 can be configured to receive/process miscellaneous content 116 from any number, type, etc., of sources. According to some embodiments, the miscellaneous content 116 can include motion information, e.g., obtained using 3D scanners, LiDAR, depth cameras, stereo vision systems, photogrammetry, time-of-flight cameras, and so on. The motion information can enable a variety of useful information to be derived, such as the number of individuals in a scene, gestures exhibited by the individuals, skeletal structures/movements of the individuals (that can be used, for example, to generate animated avatars), and so on. The motion information can also be compared against the video feed content 106 (and/or vice-versa) to provide enhanced processing of the motion information and/or the video feed content 106.

In another example, the miscellaneous content 116 can include scene information, such as ambient light measurements, temperature measurements, room acoustics measurements, and so on. The scene information can enable a variety of useful information to be derived, such as the predicted mood(s) of the individual(s), the predicted energy level(s) of the individual(s), the manner in which audio/video output content 124 should be output into the room, and so on. It is noted that the foregoing examples are not meant to be limiting, and that the miscellaneous content 116 can include any type, form, etc., of content, at any level of granularity, without departing from the scope of this disclosure. It is additionally noted that some or all of the information included in the miscellaneous content 116 described herein can be pre-populated within the miscellaneous content 116, and that the other content analyzer 118 can be configured to process the miscellaneous content 116 to derive other information, if any, that is not pre-populated within the miscellaneous content 116. In any case, the miscellaneous content 116 that is received/processed by other content analyzer 118 can be provided (along with other content produced by other entities executing on the computing device 108) as processed content 120 to the audio/video output content generator 122.

According to some embodiments, the audio/video output content generator 122 can be configured to receive and further-process the processed content 120 (that is produced by the audio/video feed analyzer 110, the audio content analyzer 114, and/or the other content analyzer 118) to produce audio/video output content 124. In particular, and according to some embodiments, the audio/video output content generator 122 can be configured to generate audio output content 124 that is based on (1) the audio/video feed content 106, (2) the audio content 112 (i.e., the audio metadata 112-1 and/or audio data 112-2 thereof), and/or (3) the miscellaneous content 116. According to some embodiments, the audio/video output content generator 122 can reduce the volume of vocal sounds included in the audio data 112-2 based on configuration settings to thereby enable the individual(s) to sing-along to the audio data 112-2 with the underlying vocals fully intact, partially intact (to any degree), or eliminated. The audio/video output content generator 122 can also modify the audio feed content 106 (and/or audio data 112-2) in any manner, at any level of granularity, when generating the audio output content 124. Such modifications can include, for example, applying auto-tune filters, reverb filters, delay filters, chorus filters, distortion filters, flanger/phaser filters, vocal doubler filters, and so on. It is noted that any of the foregoing processing can be implemented by the audio/video feed analyzer 110 and/or the audio/video output content generator 122 without departing from the scope of this disclosure.

Additionally, and according to some embodiments, the audio/video output content generator 122 can be configured to generate video output content 124 that is based on (1) the audio/video feed content 106, (2) the audio content 112 (i.e., the audio metadata 112-1 and/or audio data 112-2 thereof), and/or (3) the miscellaneous content 116. According to some embodiments, the video feed content 106 can be modified, supplemented, etc., to include video effects. For example, when one or more individuals are included in the video feed content 106, a background animation can be dynamically generated to surround the silhouette(s) of the individual(s), video effects that replace, stem from, etc., the silhouette(s) of the individuals can be incorporated, and so on. It is noted that the foregoing examples are not meant to be limiting, and that any number, type, form, etc., of video effects can be included in the video output content 124, at any level of granularity, without departing from the scope of this disclosure.

Additionally, and according to some embodiments, the aforementioned video effects can be guided by (1) the audio/video feed content 106, (2) the audio content 112 (i.e., the audio metadata 112-1 and/or audio data 112-2 thereof), and/or (3) the miscellaneous content 116. For example, as described in greater detail below in conjunction with FIGS. 2-4, the lyric information included in the audio metadata 112-1, valence information included in the audio metadata 112-1, and so on, can guide the video effects, the video effect transition times, etc., that are included in the video output content 124. In particular, the audio/video output content generator 122 can be configured to analyze the lyric information, valence information, etc., to inform the video effects that should be applied, the times at which video effect transitions should occur, and so on.

In another example, one or more of the title, artist, album, album artist, track number, disc number, genre, year, duration, composer, lyricist, conductor, band, comment, bpm, key, rating, language, publisher, ISRC, UPC, copyright, original artist, compilation, mood, podcast, and artwork information can inform the video effects that should be applied, the times at which video effect transitions should occur, and so on. For example, the album artwork can provide a basis for one or more color tones of one or more video effects to be applied to the video output content 124. In yet another example, the genre, year, duration, BPM, rating, mood, etc., can provide a basis for the video effects applied, the rates/times at which the video effects transition, and so on. In yet another example, any of the foregoing characteristics can be looked up in a database to obtain preferred video effects, video effect transition times, and so on. For example, a specific artist of a song, publisher thereof, etc., may distribute a pre-defined set of video effects, video effect transition times, etc., to be applied when the song is played back in accordance with the techniques described herein. It is noted that the foregoing examples are not meant to be limiting, and that any aspect of any of the content described herein, at any level of granularity, can inform how the video effects, their transitions, etc., should be implemented.

Additionally, and as noted above, the audio data 112-2 (itself) can guide the manner in which video effects are applied to the video output content 124. For example, the aforementioned video effects can be based on the changing frequency/frequencies of the audio data 112-2 as it is played back. In another example, the aforementioned video effects can be based on the vocals of the audio data 112-2 as it is played back. In yet another example, the aforementioned video effects can be based on the current time of the playback of the audio data 112-2 relative to the overall duration of the audio data 112-2. It is noted that the foregoing examples are not meant to be limiting, and that the aforementioned video effects can be based on any aspect of the audio data 112-2, at any level of granularity, without departing from the scope of this disclosure.

Additionally, it is noted that the video output content 124 can be based on any property of the audio feed content 106, at any level of granularity, without departing from the scope of this disclosure. For example, the video output content 124 can be modified in any fashion, at any level of granularity, based on the current volume(s) of the audio feed content 106 (e.g., the current volume of the individual's voice or the individuals' voices), the current frequency band(s) of the audio feed content 106, (e.g., the current pitch of the individual's voice or individuals' voices), and so on.

According to some embodiments, the audio/video output content 124 that is generated by the audio/video output content generator 122 can be output to one or more display devices 126 and one or more speakers 128. For example, in the example scenario described herein where computing device 108 represents a set-top box, the set-top box can be connected to a television that includes a display device 126 and speakers 128. In another example, the set-top box can be connected to a television that includes a display device 126, and an entertainment system that includes speakers 128. In any case, the display device(s) 126/speaker(s) 128, in turn, can output the audio/video output content 124 so that it is human-perceptible.

It should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

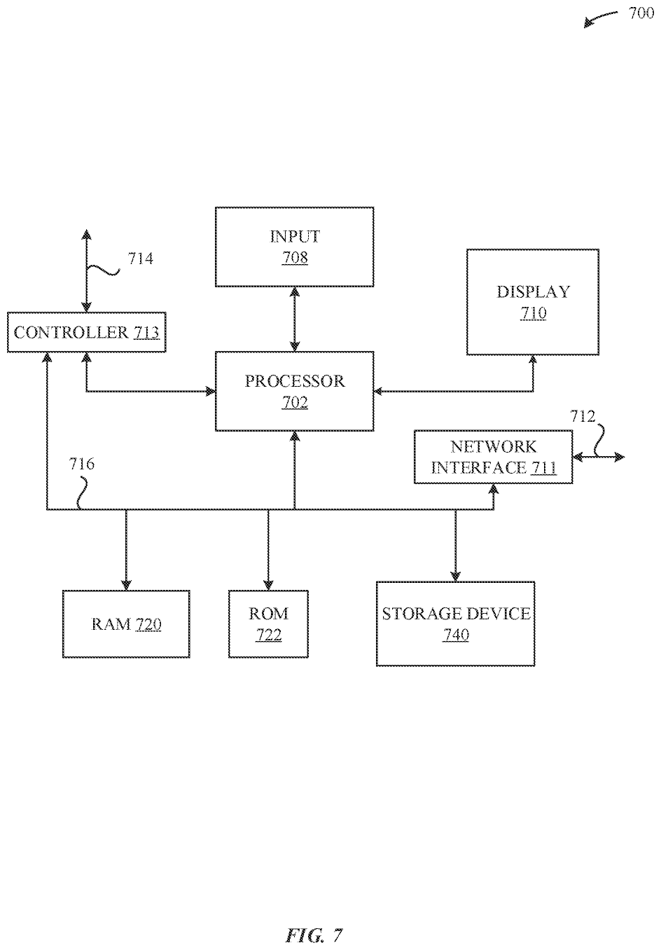

A more detailed explanation of these hardware components is provided below in conjunction with FIG. 7. It should additionally be understood that the computing devices can include additional entities that enable the implementation of the various techniques described herein without departing from the scope of this disclosure. It should additionally be understood that the entities described herein can be combined or split into additional entities without departing from the scope of this disclosure. It should further be understood that the various entities described herein can be implemented using software-based or hardware-based approaches without departing from the scope of this disclosure.

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2-6.

FIG. 2 illustrates a conceptual diagram 200 of a technique for generating video effects based on lyric information included in the audio metadata 112-1 of audio content 112, according to some embodiments. As shown in FIG. 2, the lyric information includes a collection of lyric lines 201 that are spoken/sung in the audio data 112-2 of example audio content 112. According to some embodiments, each lyric line 201 can include any amount of information that pertains to a respective lyric line spoken/sung in the audio data 112-2, such as the words that are spoken/sung, volumes at which the words are spoken/sung, and so on. Additionally, each lyric line 201 can include timing information associated with the lyric line 201—such as a start time that a first word of the lyric line 201 is spoken/sung relative to the duration of the audio data 112-2, a finish time that a last word of the lyric line 201 is spoken/sung relative to the duration of the audio data 112-2, and so on. Each lyric line 201 can also include finer-granularity timing information, such as the start/finish times at which each word of the lyric line 201 is spoken/sung.

Additionally, and as illustrated in FIG. 2, the lyric information can include categorized groups of lyric lines 201. For example, each categorized group can include any number of lyric lines 201, and be categorized as “intro”, “verse”, “pre-chorus”, “chorus”, “bridge”, “outro”, and so on. FIG. 2 illustrates examples of such categorized groups, which include verse lyrics 202 (that encompass lyric lines 201-1 to 201-4), pre-chorus lyrics 204 (that encompass lyric lines 201 201-5 to 201-8) and chorus lyrics 206 (that encompass lyric lines 201-9 to 201-12). Additionally, each categorized group can include timing information, such as a time at which the first word of the first lyric line of the categorized group is spoken/sung, a time at which the last word of the last lyric line of the categorized group is spoken/sung, and/or any other timing information. It is noted that categorized groups can also be established for portions of the audio data 112-2 that do not necessarily include lyric lines 201, as is often the case, for example, with intros and outros of songs, transition times between categorized groups, and so on. It is noted that the foregoing examples are not meant to be limiting, and that any amount, type, etc., of information associated with the lyrics of the audio data 112-2, at any level of granularity, can be included in the audio metadata 112-1 without departing from the scope of this disclosure.

As shown in FIG. 2, different video effect transition times 220 can be established based on the lyric information included in the audio metadata 112-1. For example, a video effect transition time 220 can be established at some time between the end of a given lyric line 201 and the start of a successive lyric line 201. A video effect transition time 220 can also be established at some time between categorized groups of lyric lines 201 (e.g., a video effect transition time 220 at some time between the verse lyrics 202 and the pre-chorus lyrics 204, as well as a video effect transition time 220 at some time between the pre-chorus lyrics 204 and the chorus lyrics 206). It is noted that the foregoing example approaches for generating video effect transition times 220 are not meant to be limiting, and that any approach can be utilized for generating video effect transition times 220 based on lyric lines 201 (and/or other information), at any level of granularity, without departing from the scope of this disclosure. For example, video effect transition times 220 can be established within a given lyric line 201 (e.g., each time a threshold number of words of the lyric line 201 are spoken/sung). In another example, a given video effect transition time 220 can be shifted (e.g., increased/decreased) based on the current video effect that is being implemented and the video effect that will be implemented (i.e., when the video effect transition takes place). In yet another example, the lyric information can guide the manner in which the video effect transitions (themselves) are implemented when transitioning between a current video effect and a subsequent video effect (e.g., fading, zooming, cascading, dissolving, etc.). Again, these examples are not meant to be limiting.

Additionally, it is noted that the lyric information of the audio metadata 112-1 can, in addition to guiding the video effect transition times 220, also guide the video effects that are implemented. For example, in the example illustrated in FIG. 2—which effectively involves applying a different video effect each time a given lyric line 201 is spoken/sung—each video effect can be randomly selected, be selected based on video effect information that accompanies the lyric information (e.g., per-lyric information, per-lyric-line information, per-lyric-group information, etc.), be based on the audio data 112-2 that corresponds to the lyric line 201, be based on other audio metadata 112-1 that corresponds to the lyric line 201, and so on. It is noted that the foregoing examples are not meant to be limiting, and that the video effects can be selected, programmed, etc., based on any aspect of the audio content 112 (or other information, such as audio/video feed content 106, miscellaneous content 116, etc.), at any level of granularity, without departing from the scope of this disclosure. Accordingly, FIG. 2 illustrates example approaches through which lyric information included in audio metadata 112-1 of audio content 112 can guide the manner in which video effects and/or video effect transitions are implemented when playing back the audio data 112-2 of the audio content 112.

FIG. 3 illustrates a conceptual diagram 300 of a technique for generating video effects based on valence segments included in the metadata of audio content, according to some embodiments. As shown in FIG. 3, the lyric information includes a collection of valence segments 301 associated with the audio data 112-2 of example audio content 112. According to some embodiments, each valence segment 301 can describe, qualify, etc., a respective portion of the audio data 112-2. As previously described herein, valence designations can include, for example, a euphoric valence, an excited valence, a positive valence, a serene valence, a reflective valence, a neutral valence, a melancholic valence, a negative valence, an aggressive valence, and so on. Additionally, each valence segment 301 can include timing information associated with the valence segment 301—such as a start time of the audio data 112-2 where the valence segment 301 applies and an end time of the audio data 112-2 where the valence segment 301 no longer applies. Each valence segment 301 can also include finer-granularity timing information, such as the start/finish times of sub-valence segments included within the valence segment 301. It is noted that the foregoing examples are not meant to be limiting, and that any amount, type, etc., of information associated with the valences of the audio data 112-2, at any level of granularity, can be included in the audio metadata 112-1 without departing from the scope of this disclosure.

As shown in FIG. 3, different video effect transition times 302 can be established based on the valence segments 301 included in the audio metadata 112-1. For example, a video effect transition time 302 can be established between the end of a given valence segment 301 and the start of a successive valence segment 301. In another example, video effect transition times 302 can be established within a given valence segment 301 (e.g., each time a threshold amount of the underlying audio data 112-2 associated the valence segment 301 is played back). In another example, a given video effect transition time 302 can be shifted (e.g., increased/decreased) based on the current video effect that is being implemented and the video effect that will be implemented (i.e., when the video effect transition takes place). It is noted that the foregoing example approaches for generating video effect transition times 302 are not meant to be limiting, and that any approach can be utilized for generating video effect transition times 302 based on valence segments 301 (and/or other information), at any level of granularity, without departing from the scope of this disclosure.

Additionally, it is noted that the valence information of the audio metadata 112-1 can, in addition to guiding the video effect transition times 302, also guide the video effects that are implemented. For example, in the example illustrated in FIG. 3—which effectively involves applying a different video effect each time a valence segment 301 starts/completes—each video effect can be randomly selected, be selected based on video effect information that accompanies the valence segment 301, be based on the audio data 112-2 that corresponds to the valence segment 301, be based on other audio metadata 112-1 that corresponds to the valence segment 301, and so on. It is noted that the foregoing examples are not meant to be limiting, and that the video effects can be selected, programmed, etc., based on any aspect of the audio content 112 (or other information, such as audio/video feed content 106, miscellaneous content 116, etc.), at any level of granularity, without departing from the scope of this disclosure. Accordingly, FIG. 3 illustrates example approaches through which valence information included in audio metadata 112-1 of audio content 112 can guide the manner in which video effects and/or video effect transitions are implemented when playing back the audio data 112-2 of the audio content 112.

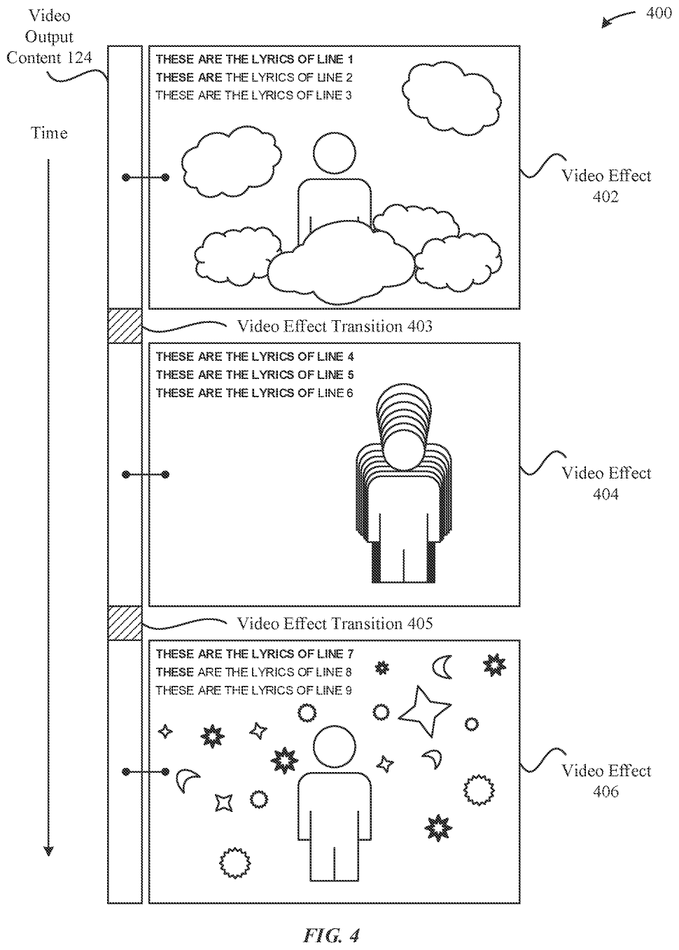

As a brief aside, it is again noted that although FIGS. 3-4 focus on generating video effects/video effect transition times based on lyric information and valence information, the embodiments are not limited to utilizing only such information. To the contrary, the video effects/video effect transition times can be based on any combination of information—including, but not limited to, the audio/video feed content 106, the audio content 112, the miscellaneous content 116, and the processed content 120—at any level of granularity, without departing from the scope of this disclosure.

Additionally, FIG. 4 illustrates a conceptual diagram 400 of example video effects, as well as video effect transitions, according to some embodiments. As shown in FIG. 4, a first portion of video output content 124 can initially include a cloud-based video effect 402 that superimposes clouds within the video of an individual (e.g., obtained through video feed content 106). In turn, when a video effect transition 403 is reached (e.g., as determined using the video effect transition time generation techniques discussed herein)—the audio/video output content 124 can transition to including a warping video effect 404 that expands the silhouette of the individual. Additionally, when a video effect transition 405 is reached, the audio/video output content 124 can transition to an astronomy-based video effect 406 that superimposes animated stars, moons, etc., within the video of the individual. It is noted that the example video effects illustrated in FIG. 4 are not meant to be limiting, and that any number, type, kind, form, etc., of video effects can be implemented, at any level of granularity, without departing from the scope of this disclosure.

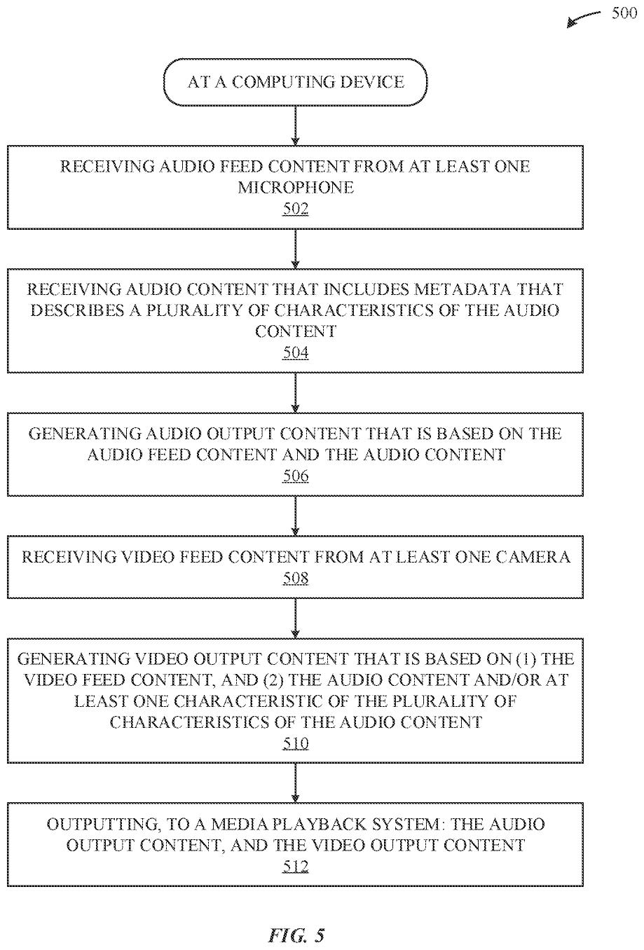

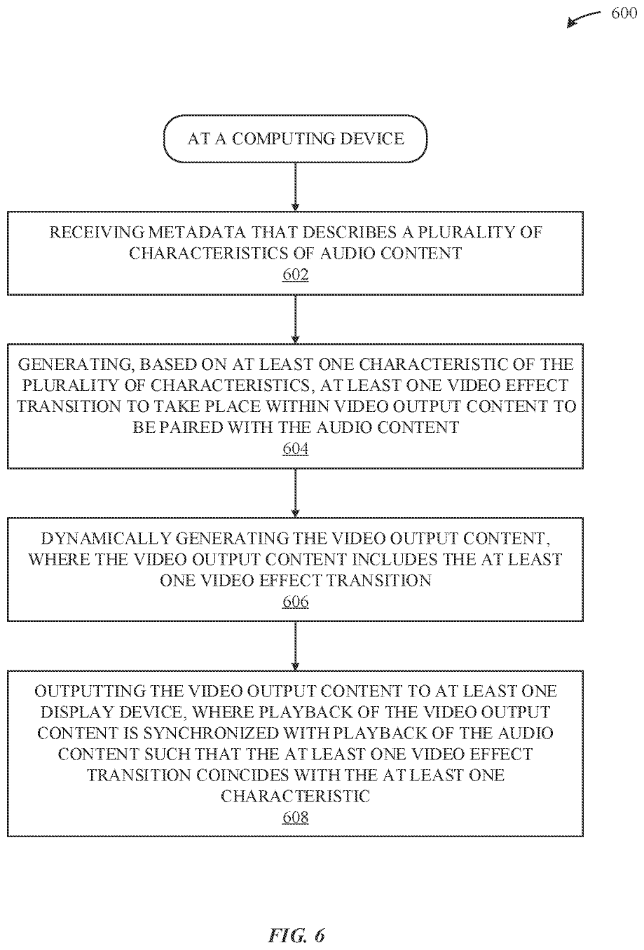

Accordingly, FIGS. 2-4 illustrate conceptual diagrams of the manner in which video effects can be generated based on metadata and/or audio data of audio content, according to some embodiments. High-level breakdowns of the manners in which the entities discussed in conjunction with FIGS. 1-4 can interact with one another will now be provided below in conjunction with FIGS. 5-6.

FIG. 5 illustrates a method 500 for implementing a sing-along session, according to some embodiments. As shown in FIG. 5, the method 500 begins at step 502, where the computing device 108 receives audio feed content from at least one microphone (e.g., as described above in conjunction with FIGS. 1-4). At step 504, the computing device 108 receives audio content that includes metadata that describes a plurality of characteristics of the audio content (e.g., as also described above in conjunction with FIGS. 1-4). At step 506, the computing device 108 generates audio output content that is based on the audio feed content and the audio content (e.g., as also described above in conjunction with FIGS. 1-4).

At step 508, the computing device 108 receives video feed content from at least one camera (e.g., as also described above in conjunction with FIGS. 1-4). At step 510, the computing device 108 generates video output content that is based on (1) the video feed content, and (2) the audio content and/or at least one characteristic of the plurality of characteristics of the audio content (e.g., as also described above in conjunction with FIGS. 1-4). At step 512, the computing device 108 outputs, to a media playback system: the audio output content, and the video output content.

FIG. 6 illustrates a method 600 for generating video effects for sing-along sessions, according to some embodiments. As shown in FIG. 6, the method 600 begins at step 602, where the computing device 108 receives metadata that describes a plurality of characteristics of audio content (e.g., as described above in conjunction with FIGS. 1-4). At step 604, the computing device 108 generates, based on at least one characteristic of the plurality of characteristics, at least one video effect transition to take place within video output content to be paired with the audio content (e.g., as also described above in conjunction with FIGS. 1-4).

At step 606, the computing device 108 dynamically generates the video output content, where the video output content includes the at least one video effect transition (e.g., as also described above in conjunction with FIGS. 1-4). At step 608, the computing device 108 outputs the video output content to at least one display device, where playback of the video output content is synchronized with playback of the audio content such that the at least one video effect transition coincides with the at least one characteristic.

FIG. 7 illustrates a detailed view of a computing device 700 that can be used to implement the various techniques described herein, according to some embodiments. In particular, the detailed view illustrates various components that can be included in the computing devices described in conjunction with FIG. 1. As shown in FIG. 7, the computing device 700 can include a processor 702 that represents a microprocessor or controller for controlling the overall operation of the computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, and so on. Still further, the computing device 700 can include a display 710 that can be controlled by the processor 702 (e.g., via a graphics component) to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include a wireless transceiver.

As noted above, the computing device 700 also includes the storage device 740, which can comprise a single disk or a collection of disks (e.g., hard drives). In some embodiments, storage device 740 can include flash memory, semiconductor (solid-state) memory or the like. The computing device 700 can also include a Random-Access Memory (RAM) 720 and a Read-Only Memory (ROM) 722. The ROM 722 can store programs, utilities, or processes to be executed in a non-volatile manner. The RAM 720 can provide volatile data storage, and stores instructions related to the operation of applications executing on the computing device 700.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

The terms “a,” “an,” “the,” and “said” as used herein in connection with any type of processing component configured to perform various functions may refer to one processing component configured to perform each and every function, or a plurality of processing components collectively configured to perform the various functions. By way of example, “A processor” configured to perform actions A, B, and C may refer to one or more processors configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method for implementing a sing-along session, the method comprising, by a computing device:
receiving audio feed content from at least one microphone;
receiving audio content that includes metadata that describes a plurality of characteristics of the audio content;
generating audio output content that is based on the audio feed content and the audio content;
receiving video feed content from at least one camera;
generating video output content that is based on:
the video feed content, and
the audio content and/or at least one characteristic of the plurality of characteristics of the audio content; and
outputting, to a media playback system:
the audio output content, and
the video output content.

2. The method of claim 1, wherein the media playback system comprises:
at least one display device; and
at least one audio output device.

3. The method of claim 2, wherein:
the computing device comprises a set-top box,
the set-top box receives the video feed content from at least one first peripheral device that includes the at least one camera, and
the set-top box receives the audio feed content from the at least one first peripheral device or at least one second peripheral device, wherein the at least one first or second peripheral device includes the at least one microphone.

4. The method of claim 1, wherein, when the video output content is based on the at least one characteristic of the plurality of characteristics of the audio content:
the at least one characteristic comprises lyric content,
the lyric content identifies at least one separation between two lyric lines and/or two groups of lyric lines, and
the video output content includes at least one video effect transition that coincides with the at least one separation.

5. The method of claim 1, wherein, when the video output content is based on the at least one characteristic of the plurality of characteristics of the audio content:
the at least one characteristic comprises valence content,
the valence content identifies at least one separation between two successive portions of the audio content having respective valence values that are distinct from one another, and
the video output content includes at least one video effect transition that coincides with the at least one separation.

6. The method of claim 5, wherein the respective valence value of a given portion of the audio content is based on at least one of:
at least one underlying meaning of at least a portion of lyrics included in the given portion of the audio content,
a tempo of the given portion of the audio content, and/or
a frequency band of the given portion of the audio content.

7. The method of claim 1, wherein the video output content is further based on the audio feed content.

8. A media playback system for implementing a sing-along session, the media playback system comprising:
at least one microphone;
at least one camera;
at least one display device;
at least one speaker;
at least one computing device that includes:
at least one processor; and
at least one memory storing instructions that, when executed by the at least one processor, cause the at least one computing device to carry out steps that include:
receiving audio feed content from the at least one microphone;
receiving audio content that includes metadata that describes a plurality of characteristics of the audio content;
generating audio output content that is based on the audio feed content and the audio content;
receiving video feed content from the at least one camera;
generating video output content that is based on:
the video feed content, and
the audio content and/or at least one characteristic of the plurality of characteristics of the audio content; and
outputting:
the audio output content to the at least one speaker, and
the video output content to the at least one display device.

9. The media playback system of claim 8, wherein:
the at least one computing device comprises a set-top box,
the set-top box receives the video feed content from at least one first peripheral device that includes the at least one camera, and
the set-top box receives the audio feed content from the at least one first peripheral device or at least one second peripheral device, wherein the at least one first or second peripheral device includes the at least one microphone.

10. The media playback system of claim 8, wherein, when the video output content is based on the at least one characteristic of the plurality of characteristics of the audio content:
the at least one characteristic comprises lyric content,
the lyric content identifies at least one separation between two lyric lines and/or two groups of lyric lines, and
the video output content includes at least one video effect transition that coincides with the at least one separation.

11. The media playback system of claim 8, wherein, when the video output content is based on the at least one characteristic of the plurality of characteristics of the audio content:
the at least one characteristic comprises valence content,
the valence content identifies at least one separation between two successive portions of the audio content having respective valence values that are distinct from one another, and
the video output content includes at least one video effect transition that coincides with the at least one separation.

12. The media playback system of claim 11, wherein the respective valence value of a given portion of the audio content is based on at least one of:
at least one underlying meaning of at least a portion of lyrics included in the given portion of the audio content,
a tempo of the given portion of the audio content, and/or
a frequency band of the given portion of the audio content.

13. The media playback system of claim 8, wherein the video output content is further based on the audio feed content.

14. A method for generating video effects for sing-along sessions, the method comprising, by a computing device:
receiving metadata that describes a plurality of characteristics of audio content;
generating, based on at least one characteristic of the plurality of characteristics, at least one video effect transition to take place within video output content to be paired with the audio content;
dynamically generating the video output content, wherein the video output content includes the at least one video effect transition; and
outputting the video output content to at least one display device, wherein playback of the video output content is synchronized with playback of the audio content such that the at least one video effect transition coincides with the at least one characteristic.

15. The method of claim 14, wherein:
the at least one characteristic comprises lyric content,
the lyric content identifies at least one separation between two lyric lines and/or two groups of lyric lines, and
the at least one video effect transition coincides with the at least one separation.

16. The method of claim 15, wherein a group of lyric lines comprises:
two or more successive intro lyric lines,
two or more successive verse lyric lines,
two or more successive pre-chorus lyric lines,
two or more successive chorus lyric lines,
two or more successive bridge lyric lines, or
two or more successive outro lyric lines.

17. The method of claim 14, wherein:
the at least one characteristic comprises valence content,
the valence content identifies at least one separation between two successive portions of the audio content having respective valence values that are distinct from one another, and
the at least one video effect transition coincides with the at least one separation.

18. The method of claim 17, wherein the respective valence value of a given portion of the audio content corresponds to:
a euphoric valence,
an excited valence,
a positive valence,
a serene valence,
a reflective valence,
a neutral valence,
a melancholic valence,
a negative valence, and/or
an aggressive valence.

19. The method of claim 17, wherein the respective valence value of a given portion of the audio content is based on at least one of:
at least one underlying meaning of at least a portion of lyrics included in the given portion of the audio content,
a tempo of the given portion of the audio content, and/or
a frequency band of the given portion of the audio content.

20. The method of claim 14, wherein the at least one video effect transition takes place at a first time within the video output content that coincides with a second time within the audio content that is derived from the at least one characteristic.
